(19) United States
(12) Patent Application Publication
(10) Pub. No.: US 2025/0298594 A1
(43) Pub. Date: Sep. 25, 2025

(54) AUTOMATED DEPENDENCY MANAGEMENT FOR APPLICATION DEPLOYMENT

(71) Applicant: DISH Network Technologies India Private Limited, Bengaluru (IN)

(72) Inventors: Yogesh Malhotra, Bangalore (IN); Praveen Kumar Nadipi Karunakara, Bangalore (IN); Vedam Jude Pragash, Bangalore (IN); Shishir Pandey, Secunderabad (IN)

(21) Appl. No.: 19/085,444

(22) Filed: Mar. 20, 2025

(30) Foreign Application Priority Data
Mar. 20, 2024 (IN) 202441021200

(51) Int. Cl. G06F 8/60; G06F 8/41

(52) U.S. Cl. CPC G06F 8/60; G06F 8/433

(57) ABSTRACT

Systems, devices, and methods related to automated dependency management for deployment of an application are provided. An example method includes generating an initial dependency graph for an application to be deployed in a target environment, the initial dependency graph indicating a predetermined reference state of resources associated with the application and dependency relationships of the resources. The method further includes tracking the resources associated with the application after the application is deployed. The method further includes generating an updated dependency graph for the application after the application is deployed, the updated dependency graph corresponding to an updated state of the resources associated with the application and the dependency relationships of the resources. The method further includes detecting a change in at least one of the resources and/or a change in at least one of the dependency relationships of the resources between the updated state and the reference state.

### CROSS REFERENCE TO RELATED APPLICATIONS

This application claims priority to Indian Provisional Patent Application No. 202441021200, titled “AUTOMATED GOVERNANCE AND COMPLIANCE GATING OF APPLICATION DEPLOYMENTS,” filed on Mar. 20, 2024, in the Indian Intellectual Property Office, the disclosure of which is incorporated by reference in its entirety for all purposes. This application is also related to U.S. patent application Ser. No. 18/958,696, filed on Nov. 25, 2024, titled “AUTOMATED GOVERNANCE AND COMPLIANCE GATING OF APPLICATION DEPLOYMENTS,” Attorney Docket No. P2024-05-03 (1446932), filed concurrently, titled “NATURAL LANGUAGE INTERFACE,” and Attorney Docket No. P2024-05-04 (1446934), filed concurrently, titled “CHANGE ANALYSIS FOR APPLICATION DEPLOYMENT,” the disclosures of which are incorporated by reference in their entirety for all purposes.

### BACKGROUND

Deployment of a software application typically involves a sequential and multi-stage process, where the software application is released and updated through a step-by-step procedure. Conventional methods for software deployment often follows a linear trajectory, starting with building and development, progressing through validation and testing, and ultimately reaching production deployment. Developers and operations teams are involved in each stage and manage tasks such as code compilation, testing, configuration, and release. A common example of the conventional method is the use of manual deployment scripts or runbooks, where operators execute a series of predefined steps to deploy the software to production servers. However, this conventional method is prone to drawbacks and limitations. Manual interventions can lead to human errors and result in deployment inconsistencies across different environments. In addition, the process tends to be time-consuming and may cause downtime as updates are implemented. Further, the manual deployment process lacks automated decision-making and can hinder agility and scalability.

### BRIEF SUMMARY OF THE DISCLOSURE

The present disclosure provides systems, devices, and methods related to automated management of application deployment. In one example, a method includes generating an initial dependency graph for an application to be deployed in a target environment, the initial dependency graph indicating a predetermined reference state of resources associated with the application and dependency relationships of the resources. The method further includes tracking, continuously, the resources associated with the application after the application is deployed in the target environment. The method further includes generating an updated dependency graph for the application after the application is deployed, the updated dependency graph corresponding to an updated state of the resources associated with the application and the dependency relationships of the resources. The method further includes detecting a change in at least one of the resources and/or a change in at least one of the dependency relationships of the resources between the updated state and the reference state.

In another example, a computer system includes one or more processors and a computer-readable storage media storing computer-executable instructions, wherein, the instructions when executed by the one or more processors, cause the computer system to generate an initial dependency graph for an application to be deployed in a target environment. The initial dependency graph indicates a predetermined reference state of resources associated with the application and dependency relationships of the resources. The instructions when executed by the one or more processors, further cause the computer system to track, continuously, the resources associated with the application once the application is deployed in the target environment and generate an updated dependency graph for the application after the application is deployed. The updated dependency graph corresponds to an updated state of the resources associated with the application and the dependency relationships of the resources. The instructions when executed by the one or more processors, further cause the computer system to detect a change in at least one of the resources and/or a change in at least one of the dependency relationships of the resources between the updated state and the reference state.

In accordance with some embodiments, the present disclosure also provides a non-transitory machine-readable storage medium encoded with instructions, the instructions executable to cause one or more electronic processors of a media device to perform any one of the methods described in the present disclosure.

### BRIEF DESCRIPTION OF THE DRAWINGS

FIG. 1 is a block diagram illustrating an example communications system for automated deployment of applications, according to various embodiments of the present disclosure.

FIG. 2 is a block diagram illustrating an example of the automated dependency manager shown in FIG. 1, according to various embodiments of the present disclosure.

FIG. 3A is a schematic diagram illustrating an example of dependency graph associated with an application, according to various embodiments of the present disclosure.

FIG. 3B is a schematic diagram illustrating another example of dependency graph of multiple applications, according to various embodiments of the present disclosure.

FIG. 3C is a schematic diagram illustrating a process of updating dependency graphs for an application during deployment, according to various embodiments of the present disclosure.

FIG. 4 is an example of a flow diagram illustrating interaction among components of the automated dependency manager shown in FIG. 2, according to various embodiments of the present disclosure.

FIG. 5A is a flow diagram illustrating an example method for dependency management, according to various embodiments of the present disclosure.

FIG. 5B is a flow diagram illustrating another example method for dependency management, according to various embodiments of the present disclosure.

FIG. 6 illustrates an example computer system or computer device, according to various embodiments of the present disclosure.

### DETAILED DESCRIPTION OF THE DISCLOSURE

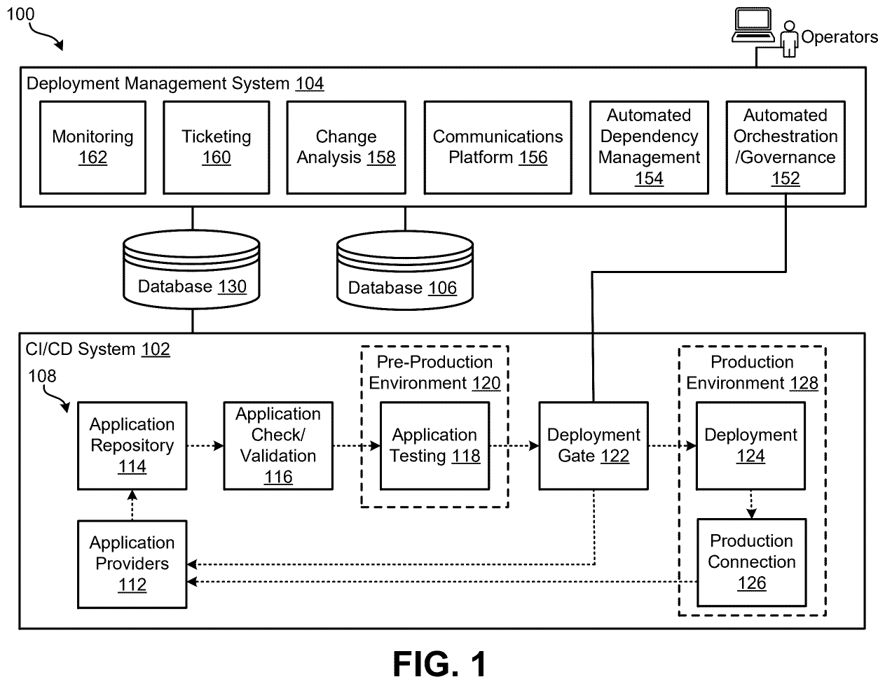

FIG. 1 is a block diagram illustrating an example communications system 100 for deployment of software applications (hereinafter “applications”) in a software development environment. In the illustrated example, communications system 100 includes, among other components, a continuous integration/continuous deployment system 102 (hereinafter “CI/CD system 102”), a deployment management system 104, and a database 106. Each component included in the communications system 100 may be a hardware component, a software component, or a combination of both hardware and software. Additional or fewer components may be included in the communications system 100. The CI/CD system 102 is generally responsible for deployment of applications through CI/CD pipeline execution. The deployment management system 104 is in communication with the CI/CD system 102 and is operable to allow operators to manage the deployment process of an application through execution of a CI/CD pipeline for the application, monitor the status of CI/CD pipeline execution of a software application, access various application data sources from database 130, determine whether the software application is ready for release, and control block or release of the application through a deployment gate 122 of the CI/CD system. In some embodiments, the deployment management system 104 may be integrated with the CI/CD system 102 to form a single system that includes the components of both.

The CI/CD system 102 further includes, among other components, application providers 112, application inventory 114 (also referred to as “application inventory”), application check and validation system 116, application testing system 118, deployment gate 122, deployment execution system 124, production connections 126, and database 130. Application providers 112 are entities or services that supply the necessary application packages, application artifacts, codes, application configuration data, service applications, docker images, dependencies, or updates of applications to the CI/CD system 102. Application providers 112 may also supply external libraries, third-party components, or internal dependencies for the development and deployment process. In some embodiments, application provider 112 may be an individual software vendor (ISV). In some embodiments, the CI/CD system 102 is automatically triggered to initiate execution of a CI/CD pipeline 108 for deployment of an application upon receiving a request for deploying the application or a request for a change/update/modification to an application.

The application inventory 114 is a centralized storage system where source codes, artifacts, and other relevant files are stored, classified, organized, and maintained. In some embodiments, the application inventory 114 serves as a version-controlled repository and is configured to track, monitor, manage, and update changes to the application codes and make the application codes accessible to the CI/CD system 102 and any components thereof for automated integration and deployment. Version data of the application and any components thereof may be stored in database 130.

The application check validation system 116 is generally responsible for conducting checks, verifications, and validations on the application artifacts before they progress further in the CI/CD pipeline 108. The application check validation system 116 may further include various modules such as code quality assessment module, security scan module, security check module, sentinel check module, dependency check module, environment lock module, metrics and reports module, among others.

For example, the code quality assessment module may be configured to utilize static code analysis tools to evaluate the overall quality of the application according to predetermined standards for maintainability, readability, and adherence to coding standards. The security scan module is configured to conduct security scans on the codebase of the application artifact to identify vulnerabilities, potential exploits, and adherence to security best practices, based on predetermined standards. The security check module is configured to check the security-related aspects of the codebase, including authentication mechanisms, encryption protocols, and secure coding protocols. The sentinel check module is configured to implement automated validation routines or scripts to assess whether the predefined conditions or criteria are met before allowing the application artifacts to proceed further in the CI/CD pipeline 108.

The dependency check module is configured to check and validate dependencies within an application. Dependencies may include external libraries, frameworks, modules, or other components on which the application relies. In some embodiments, the dependency check module is configured to analyze the dependencies declared or utilized by the application, verify the compatibility of the dependencies with a target environment, check whether the dependencies of the application conform to version requirements, check whether the dependencies adhere to licensing requirements and organizational policies, check the overall health of dependencies. The dependency check module may generate output with outcomes of the dependency check. Dependency data of an application is stored in database 130. Directed dependency graphs generated from the dependency data are also stored in database 130.

The environment lock module is generally responsible for managing and enforcing locks on different environments during the deployment process. The environment lock module may be configured to identify different deployment environments, such as development, testing, and production, where application artifacts move through the CI/CD pipeline 108, implement a locking mechanism that can be applied to each environment individually, support time-based locks to allow the definition of specific time intervals during which an environment is locked, and monitors the status of environment locks in real-time. Environment lock data is stored in database 130.

The metrics and reports module is generally responsible for collecting, analyzing, and presenting relevant metrics and reports related to the deployment process through the CI/CD pipeline 108. The metrics and reports module may be configured to collect various data and output reports from other components within CI/CD system 102, define and track metrics that are aligned with predetermined criteria, utilizes automated analysis tools to process the collected data and derive insights, generate and manage reports based on the analyzed metrics, and present metrics and insights in a visually accessible format, such as charts, graphs, and dashboards. Performance metrics data is stored in database 130.

The application testing system 118 is generally responsible for testing the application artifacts in pre-production environment 120 before deployment in the production environment 128. The application testing system 118 may be configured to generate and configure testing environments, executing test instances of the application artifact in the configured testing environments, monitoring the testing, and generating outcome (e.g., testing report). A test environment used herein refers to a controlled and isolated setup that mimics the production environment to conduct application testing and validate the functionality, performance, and reliability of a software application. Execution of test instances includes the execution of a specific set of test cases designed to validate certain aspects of the application, such as functionality, performance, or security. Each test instance may be conducted in isolation to focus on a specific aspect of the application. Input data specific to a test environment may be used to simulate realistic conditions and interactions with the application. Expected outcomes may be determined based on the test case specifications, and the actual outcomes during execution may be compared against the expected outcome to determine whether the application passes the testing. Testing and validation data of an application is stored in database 130.

The deployment gate 122 is the final gate before deploying the application in the production environment 128. The deployment gate 122 is controlled by the deployment management system 104 to verify that the application has undergone required validation and testing, including but not limited to checking the validation status, checking for successful execution of test cases, meeting quality standards, and/or addressing any identified defects or deficiencies. The deployment gate 122 is further configured to execute an instruction to release or block the release of the deployment based on determinations whether all predetermined requirements for deployment are met. These requirements may cover functional correctness, performance, security, reliability, and compliance with predetermined or pre-established policies and standards. If the application passes all validation and testing checks, and if all predetermined requirements are met, the deployment gate 122 allows the release of the application to the production environment 128. If any issues are identified during the validation process or if predetermined requirements are not met, the deployment gate 122 holds the release of the application.

In some embodiments, the deployment gate 122 is controlled by the deployment management system 104 to allow or hold the release of the application based on a release readiness score. A release readiness score used herein refers to a quantitative or semi-quantitative measure or numerical representation that assesses the overall readiness of an application release for deployment to a production environment. The release readiness score may be determined through evaluation of various factors, including the outcomes of validation and testing processes, adherence to predefined requirements, and other relevant criteria. The release readiness score may be determined by the deployment management system 104, based on various analytical data such as the outcomes of validation and testing or relevant reports, to calculate the release readiness score. For example, a threshold release readiness score may be established and used as a standard or reference, and only the application with a release readiness score of or above the threshold release readiness score may be released by the deployment gate 122 to the production environment 128.

The deployment execution system 124 is generally responsible for executing deployment instances of the application released to the production environment and exposing the application to production connections 126. The deployment execution system 124 may coordinate with production connections 126 to integrate the deployed application with other systems, services, and components within the production environment 128. The deployment execution system 124 may also configure the production environment 128 (e.g., update configuration files, adjust database settings, etc.) to accommodate the released application. The production environment is established on an infrastructure. In some embodiments, the production environment is established on a cloud-computing platform. The deployment execution system 124 provides various resources, such as infrastructure resources, platform resources, and application resources for deployment of the application.

The database 130 further includes various application data sources related to the to-be-deployed application and the data generated during the CI/CD pipeline execution of the application. For example, the database 130 may include SLI/SLO/SLA data, environment lock data, reliability index data, prime time data, security data, compliance data, and calculated compliance scores, among others. Service Level Indicators (SLIs) are specific metrics that quantify the performance of a service, such as latency, error rate, and throughput. Service Level Objectives (SLOs) are the target values or ranges for these indicators that define the expected level or quality of service performance for the to-be-deployed application. Environment lock data indicates the status of different environments (e.g., development, testing, staging, production) and whether they are currently locked or available for deployments. Reliability index data includes metrics related to the reliability and stability of the application, such as system uptime, failure rates, and mean time to recovery (MTTR). Prime time data includes information about critical periods when deployments are restricted to avoid disruptions, such as times of high user activity from historical analysis and predetermined critical times. Security data includes information from various security scans and assessments and identified vulnerabilities and threats within the application. Compliance data includes information related to regulatory and internal compliance requirements that the application must adhere to. The deployment management system 104 and various modules included therein may access the data from the database 130 and use the data to determine whether the application is ready for release.

In the illustrated example of FIG. 1, the deployment management system 104 may further include, among other components, an automated orchestration and governance system 152, an automated dependency management system 154, a communications platform or hub 156, a change analysis system 158, a ticketing system 160, and a deployment monitoring system 162.

At a high level, the automated orchestration and governance system 152 is generally responsible for coordination and control over the release and deployment processes to ensure smooth, reliable, and secure delivery of application. In some embodiments, the automated orchestration and governance system 152 is configured to receive validation and testing outcomes of the application through the CI/CD pipeline 108 and generated by the CI/CD system 102, analyze the validation and testing outcomes, and determine whether the application is ready to release (e.g., calculating the release readiness score). More details of the automated orchestration and governance system 152 are described in U.S. patent application Ser. No. 18/958,696, titled “SYSTEMS AND METHODS FOR AUTOMATED GOVERNANCE OF APPLICATION DEPLOYMENT,” the disclosures of which are incorporated by reference in their entirety for all purposes.

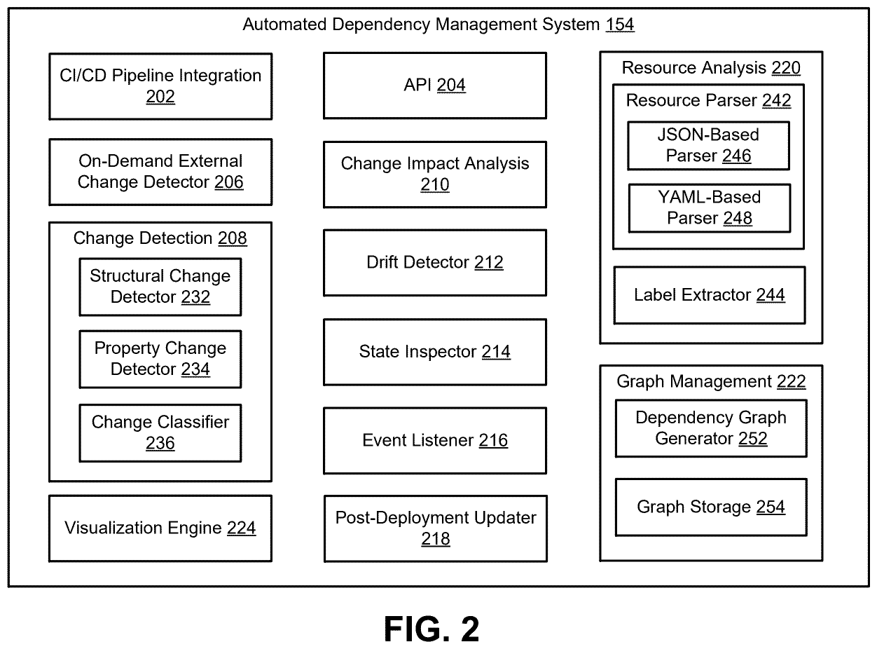

At a high level, the automated dependency management system 154 is generally responsible for identifying changes in components within an application, between the application and an upstream/downstream application, and assessing their impact on the entire application ecosystem, utilizing automated mechanisms to facilitate a dependency management process. In some embodiments, the changes are resource component changes, for example, infrastructure changes, platform changes, or application changes. The changes are not application code changes. More details of the automated dependency management system 154 are described below with references to FIG. 2.

At a high level, the communications platform 156 includes various interfaces for facilitating communications (e.g., message flow, data and file transfer, input, output, etc.) between the deployment management system 104 and the CI/CD system 102 as well as between the deployment management system 104 and operators. The communications platform 156 may include, among others, a natural language interface that provides a platform for the operators to query current and past states of the CI/CD system 102, obtain information about impact analysis of any changes or updates introduced by an application, and set up alerts and create periodic reports. More details of the communications platform 156 are described below with references to U.S. patent application with Attorney Docket No. P2024-05-03 (1446932), filed concurrently, titled “NATURAL LANGUAGE INTERFACE,” the disclosures of which are incorporated by reference in their entirety for all purposes.

At a high level, the application change analysis system (i.e., change analysis system or change analyzer) 158 is generally responsible for analyzing and providing insights into the changes and updates made to the application and all dependent applications. The change analysis system 158 may be configured to conduct cost analysis, resource optimization, and predictive modeling. The change analysis system 158 may be configured to incorporate advanced features for identifying, validating, and securing modified components within the application slated for deployment. The change analysis system 158 is further configured to determine the validations and tests required for deployment of a change/update to an application and the validations and tests required for all dependent or impacted applications associated with the software application. More details of the change analysis system 158 is described with references to U.S. patent application with Attorney Docket No. P2024-05-04 (1446934), filed concurrently, titled “CHANGE ANALYSIS FOR APPLICATION DEPLOYMENT,” the disclosures of which are incorporated by reference in their entirety for all purposes.

At a high level, the ticketing system 160 serves as a central platform and is generally responsible for managing and tracking various activities, requests, incidents and issues related to application changes and deployments. The deployment monitoring system 162 is generally responsible for monitoring deployments in real-time and providing immediate visibility into the status and progress of each deployment, detecting errors or issues during the deployment process, generating deployment data (e.g., monitoring/logging/tracing (MELT) data), and tracking resources created for or allocated to the application, tracking dependencies between different components of the application as well as upstream and downstream applications.

The database 106 may include various databases for storing the data received in and generated by the CI/CD system 102 and the deployment management system 104. The database 106 may include a relational database service (RDS) for storing and retrieving structured data where relationships between different resources or data elements need to be maintained, a graph storage or database for storing dependency graph data (e.g., the graph storage 254 of FIG. 2), a vector database, a MELT database for storing and managing data related to metrics, events, logs, traces related to a specific application or a specific infrastructure, a documentation database for storing and managing code documentation, infrastructure documentation, and other relevant information, a reliability database for storing reliability score data for applications.

FIG. 2 is a block diagram illustrating an example of the automated dependency management system 154 shown in FIG. 1. The automated dependency management system 154 may be a computer system including various engines, modules, and interfaces. In the illustrated example, automated dependency management system 154 includes a CI/CD pipeline integration module 202, an application programing interface (API) 204, an on-demand external change detector 206, a change detection module 208, a change impact analysis module 210, a drift detector 212, a state inspector 214, an event listener 216, a post-deployment updater 218, a resource analysis system 220, a dependency graph management system 222, and a visualization engine 224. The various systems, engines, interfaces, and modules included in the automated dependency management system 154 may each be a hardware component, a software component, or a combination of both. Fewer or additional components may be included in the automated dependency management system 154. In some embodiments, the automated dependency management system 154 is integrated to the automated orchestration and governance system 152.

The automated dependency management system 154 shown in FIG. 2 is generally responsible for identifying and tracking dependencies among various resources, including infrastructure, platform, and application components, generating a layered graph to visualize these relationships, enabling clear understanding and documentation of how resources interact, facilitating root cause analysis, optimizing resource management, and supporting effective change management through impact and risk assessments. The automated dependency management system 154 can provide detailed insights into dependencies, ensure system reliability and performance optimization, and maintain the health and efficiency of the overall deployment environments.

Within the automated dependency management system 154, the CI/CD pipeline integration module 202 integrates the automated dependency management system with CI/CD system 102 and the CI/CD pipelines associated with the to-be-deployed new application or change/update of the application. The CI/CD pipeline integration module 202 can automate the deployment of code changes and infrastructure updates, integrate the dependency management workflow to the CI/CD pipeline, and allow for automatic updates and checks during the build, test, and deployment stages.

The API (or API layer) 204 provides a set of protocols and tools for building software and applications, provides a platform for other systems and applications to interact with the dependency management system programmatically, facilitate communication between different software components, and provides endpoints for customizing and extending the functionality of the dependency management system 154. The API 204 may be further operable to detect integration issues and verify that the dependencies of a to-be-deployed application or change are correctly managed and up-to-date before deployment. The API 204 also allows users (e.g., authorized users with necessary privileges) to trigger dependency graph generation and perform change analysis, and allow retrieval of visualization data or raw date, etc.

In some embodiments, the API 204 further includes a Representational State Transfer (REST) based interface (e.g., a RESTful API). The REST interface is a type of web service interface that follows the principles and constraints of REST architecture and facilitates communication between different systems and applications over HTTP. The REST-based interface allows various components, such as the user interface (UI) and CI/CD pipeline workflows, to interact with the dependency management system 154 programmatically. For example, The CI/CD pipelines 108 could use the RESTful API 204 to trigger dependency checks or updates during the deployment process. The user interfaces (UIs) within the dependency management system 154 could make RESTful calls to display the current state of resources and dependency relationships, support the visualization of the dependency graphs, or allow users to manage resources directly from the UIs.

The on-demand external change detector 206 is generally responsible for identifying changes that occur outside the normal deployment process for the application. The on-demand external change detector 206 can periodically scan the current state of the target environment to which the application is deployed. This can be scheduled to run at specific intervals or triggered manually based on a request. The on-demand external change detector 206 can compare the current state of the resources associated with the application with a desired/unexpected state or a predetermined reference state. This reference state is typically defined by the last known good configuration or a baseline state. In some embodiments, on-demand external change detector 206 performs a complete scan of the infrastructure of the target environment to which application is deployed, identifies all existing resources and all changes within the target environment. The discovered resource information from the scan is propagated to the state inspector 214. The state inspector 214 can perform a comparison of the newly acquired state information with the last stored state information of the infrastructure of the target environment. The on-demand external change detector 206 labels resources that are not marked with changes coming from the CI/CD pipeline 108 for the application as external changes. These changes might include manual updates, hotfixes, or changes made by other processes outside the controlled CI/CD pipeline. The on-demand external change detector 206 can flag these external changes for further investigation or action. This helps in identifying and rectifying any unauthorized or unintended modifications. The on-demand external change detector 206 may be integrated with the other components such as the deployment monitoring system 162, the dependency graph management system 222, and the change analysis system 158, among others.

The change detection module 208 is responsible for identifying and classifying changes associated with an application by comparing a pre-deployment state of the resources associated with the application (e.g., from an initial dependency graph associated with the application stored in graph storage 254), an initial deployment state (e.g., from a deployed dependency graph of the application at the time when the application is deployed), and a post-deployment state (e.g., from an updated dependency graph of the application at a time after the application is deployed). In some embodiments, the change detection module 208 further includes a structural change detector 232, a property change detector 234, and a change classifier 236. The structural change detector 232 is operable to identify changes in the infrastructure of the system, such as the addition or removal of computing resources (e.g., instances, servers, nodes, edges, etc.) after the deployment of the application. The property change detector 234 is operable to detect changes to the properties or attributes of existing resources, such as configuration settings of the resources associated with the application. The property change detector 234 may also detect changes in the behaviors or interactions between resources associated with the application, such as changes in dependencies or communications. The change classifier 236 is operable to classify the detected changes into predefined categories for further processing and action.

In some embodiments, the changes may be classified by the change classifier 236 as additive changes, destructive changes, updating changes, relational changes, among others. For example, additive changes represent new resources being added to the graph, such as new server/node/pod, new instance, or new microservice added to the infrastructure of the target environment. The destructive changes represent removal of existing resources, such as a server, instance, or microservice removed from the infrastructure of the target environment. The updating changes represent changes to existing resources, such as modifying resource attributes, such as increasing CPU limits on pods or changing the instance type of an existing instance. The relational changes represent changes in dependencies or interactions between resources, such as a new API call introduced between microservices or an alteration of a database a service interacts with.

Various methods or tools may be used to identify and classify the changes, such as isomorphic check, subgraph isomorphism, graph edit distance, attribute change, etc. In some embodiments, the change detection module 208 can check if the pre-change and post-change dependency graphs are isomorphic by excluding resource attributes. Isomorphic graphs usually have the same structure but may differ in node/edge labels. If the graphs are not isomorphic, the change detection module 208 identifies which dependency subgraphs in the pre-change and post-change graphs are isomorphic. The change detection module 208 can heuristically assess the graph edit distance to identify the changed nodes and edges. For example, a change in edges is classified as a behavioral or relational change; a change in nodes is classified as either additive or destructive change (structural changes). If no structural or relational changes are identified, the change detection module 208 then evaluates changes in resource attributes, classifying such changes as updating (property change).

The process of change identification and classification may also depend on deployment scenarios. For example, in a greenfield deployment, the focus is on identifying the new subgraph only, as there are no existing resources to compare against. In a brownfield deployment, the change detection module 208 compares the current state with the envisioned/expected state to identify changes, as there are existing resources and dependencies to consider.

As an example use case, in an application having a microservices architecture deployed in a cloud environment, the structural change detector 232 identifies if a new microservice has been added (additive) or if an existing one has been removed (destructive), the property change detector 234 detects changes in resource attributes, such as modifying the memory allocation for a specific microservice (updating). The property change detector 234 also detects if there are new interactions between microservices or changes in existing interactions (relational). The change classifier 236 classifies these detected changes into the appropriate categories for further action and analysis.

The change impact analysis module 210 may be integrated to the change analysis system 158 and operable to perform at least the following change impact analysis: change cost estimation, change blast radius identification, and change performance cost, output an outcome of the change impact analysis, and provide the CI/CD pipeline administrator with the outcome.

The drift detector 212 within the automated dependency management system 154 is operable to identify discrepancies between the predetermined reference state and the actual state of resources. The drift detector 212 can continuously compare the current state of resources with their reference state as defined in configuration files or a baseline state and check for differences in configurations, settings, and attributes of resources. The drift detector 212 can identify any changes or deviations from the reference configuration, including unauthorized modifications, manual changes, or updates not going through the standard deployment pipeline. The drift detector 212 can monitor various resources such as servers/nodes/pods, instances, caches, databases, microservices, and network configurations for any drift. The drift detector 212 can alert administrators or relevant stakeholders when a drift is detected and/or provide insights and guidelines for correction of the drift. The drift detector 212 can generate drift analysis data and output the drift analysis, which can be integrated to the output of the change impact analysis. In some embodiments, the drift detector 212 is integrated to the change detection module 208. The drift detector 212 is also operable to send the data to update the dependency graph and feeds the identified drift to perform the change analysis.

The state inspector 214 is operable to obtain a comprehensive view of the current state of the infrastructure of the target environment and compare it with the previously known state of the infrastructure of the target environment. In some embodiments, the state inspector 214 obtains detailed information about all resources associated with the application, including configuration information such as settings and parameters that define how resources are allocated and set up, metadata such as additional information about the resources like tags and labels, current operational status of resources such as whether the resources are active, idle, or in a specific status. The state inspector 214 collects all attributes of these resources at a specific point in time. The state inspector 214 can further generate new data reflecting any changes after comparing the current state of the resources with the previously known state of the resources, creates a new snapshot of the state of the resources associated with the application using the updated data, and store the new snapshot for further comparisons and reference. The state inspector 214 can generate deployment resource state data indicating a current state of the resources associated with application (e.g., pre-deployment state, initial deployment state, post-deployment state, etc.) and provides access to the resource state data to the change detection module 208 for the change detection module 208 to detect/identify/determine a change in a resource associated with the application before and after the deployment of the application as well as after the deployment of the application. In some embodiments, the state inspector 214 is integrated to the change detection module 208.

As a use case example, the state inspector 214 may perform a workflow by inspecting all resources associated with the deployment of the application in the target environment, collecting comprehensive data on their configuration, metadata, and status, and comparing the current state data with the previously stored state. This comparison helps in identifying any changes or drifts that may have occurred. Any identified changes are labeled appropriately (e.g., additive, destructive, updating, relational). These labeled changes are propagated to the change detection module 208, which further analyzes and classifies them. The changes are also sent to the dependency graph management system 222 to update the dependency graph, such that the current state of the system can be correctly reflected. After the comparison and labeling process, the state inspector 214 generates a new snapshot of the state of the resources associated with the application, incorporating all the latest data. The snapshot is stored for future use, such that the state of the resources associated with the application is always up-to-date and can be referenced for future comparisons.

The resource analysis system 220 may include a set of services responsible for analyzing the resources associated with the deployment of the application, extracting relationship of the resources or portions of a resource, and labeling the relationships. In some embodiments, the resource analysis system 220 further includes a resource parser 242 and a label extractor 244. In some embodiments, the resource parser 242 may further include a JSON-based parser 246 and a YAML-based parser 248. For example, the JSON-based parser 246 may include a Terraform parser and a CloudFormation parser. The Terraform parser is operable to generate and parse Terraform configuration inspect JSON output. Terraform can be used for defining and provisioning the infrastructure associated with the deployment of the application, and the Terraform parser can define resources in Terraform. The CloudFormation parser is operable to process CloudFormation templates in JSON format. The AWS CloudFormation templates can be used to define AWS resources, and the CloudFormation parser can extract and process the resources. The YAML-based parser 248 may include a Helm parser and a Kubernetes manifest parser. The Helm parser is operable to render Helm charts to Kubernetes YAML manifests before parsing. Helm charts are used for managing Kubernetes applications, and the Helm parser can convert the Helm charts into YAML manifests for further analysis. The Kubernetes manifest parser is operable to directly parse Kubernetes YAML manifests. Kubernetes manifests define the desired state of Kubernetes resources, and the Kubernetes parser processes the Kubernetes manifests to extract resource information.

The resource parser 242 can perform syntax parsing, for example, analyzing the JSON formatted IaC files associated with the to-be-deployed application to extract resource definitions, properties, and relationships. The resource parser 242 can also perform resource identification, for example, assigning unique identifiers to each resource and assigning values to the identifiers, and maintain consistency across different IaC formats.

The label extractor 244 is operable in conjunction with the resource parser 242 to further process the data generated by the resource parser 242. The label extractor 244 can perform layer classification, for example, classifying the resources into different layers such as infrastructure layer, environment layer, platform layer, application layer, etc., based on various attributes. In some embodiments, classification of resources can be based on the type of the resources. For example, VPC and EC are typically classified as infrastructure. Classification of resources can also be based on custom tags or labels in the IaC files associated with the application. Classification of resources can also be based on predefined rules that map resource types to layers. The predefined rules can be derived from an up-to-date inventory or resources.

The label extractor 244 can perform cross-layer dependency identification. In some embodiments, the label extractor 244 analyzes resource properties and configurations to identify dependencies between layers. For example, an application deployment referencing a database connection string indicates a dependency on a platform layer resource.

The label extractor 244 can perform Kubernetes-specific resource analysis. In some embodiments, the label extractor 244 performs sidecar identification to analyze pod specifications and identify and label sidecar containers. The label extractor 244 can also perform service-pod mapping to group pods belonging to the same service or deployment and create logical entities. This can be updated by the dependency graph generator 252 in post-deployment mode. The label extractor 244 can also perform pod-node mapping to extract node affinity and node selector rules and predict pod-to-node dummy mappings. This can be updated by the dependency graph generator 252 in post-deployment mode and relies on labels if provided to identify pods on specific nodes. If labels are not provided, the label extractor 244 can generate placeholder labels. The resource analysis system 220 can operate in conjunction with the dependency graph generator 252 to generate an initial/preliminary dependency graph labeled according to the information extracted during the parsing and labeling process. The initial/preliminary dependency graph may include dummy values generated as placeholders for further processing by the dependency graph generator 252 in both the pre-deployment and post-deployment modes.

The dependency graph management system 222 within the automated dependency management system 154 is generally responsible for taking the input resource and labels information and converting them into storable dependency graphs. The dependency graph management system 222 may further include a dependency graph generator 252 and a graph storage 254. The dependency graph generator 252 is operable to generate dependency graphs that represent the relationships and interactions between various resources in an application deployment environment.

In some embodiments, the dependency graph generator 252 can operate in a pre-deployment mode and a post-deployment mode. In the pre-deployment mode, the dependency graph generator 252 is operable to receive parsed IaC data from the resource analysis system 220. As mentioned above, the parsed IaC data can be generated using various tools such as Terraform, CloudFormation, Helm, and Kubernetes manifests. Resources also assigned labels based on their types, tags, and/or predefined rules. For example, A Terraform configuration file defines an EC2 instance and an S3 bucket as resources associated with a to-be-deployed application. This information is extracted by the resource parser 242, and labels such as “infrastructure” for the EC2 instance and “storage” for the S3 bucket are assigned to the corresponding resources.

In the pre-deployment mode, the dependency graph generator 252 is operable to construct an initial dependency graph. For example, the dependency graph generator 252 can identify the nodes and edges created/allocated for each resource and indicate dependencies. For example, for the EC2 instance and S3 bucket, the dependency graph generator 252 can generate/allocate nodes for both resources. An edge is established if the EC2 instance depends on the S3 bucket for storage (e.g., for backup purposes). For Kubernetes-specific applications, if a new Kubernetes pod is planned but not yet deployed, the dependency graph generator 252 can generate placeholder values (e.g., an IP address and actual resource ID) for the resources.

In the pre-deployment mode, the dependency graph generator 252 is operable to perform resource identification, generate a unique identifier for each resource, and assign an actual resource ID (if available) to each resource. For example, the EC2 instance is assigned a unique ID (e.g., ec2-12345), and the S3 bucket gets another unique ID. The dependency graph generator 252 can also assign a deployment stack ID for the application. For example, the entire stack containing the EC2 instance and S3 bucket is assigned an ID. The dependency graph generator 252 can also tag the resources with tags. For example, a tag “env=dev” for development environment or a tag “env=prod” for production can be associated with respective resources.

In the post-deployment mode, the dependency graph generator 252 is operable in conjunction with the post-deployment updater 218 to perform real-time data integration. In some embodiments, once resources are allocated to the application, the post-deployment updater 218 collects real-time resource data. For example, when the EC2 instance is provisioned, the EC2 instance receives an actual IP address and instance ID from AWS, which can be collected by the post-deployment updater 218. The dependency graph generator 252 updates the dependency graph by replacing placeholder value with the actual values. For example, the placeholder IP address for the EC2 instance is replaced with the actual IP address, and the placeholder instance ID is replaced with the actual AWS instance ID. The dependency graph generator 252 updates the graph asynchronously as new data is received. For example, as a new Kubernetes pod is deployed and receives its actual IP address and pod ID, this information is updated in real time in the dependency graph. As new resources are configured, such as an additional microservice pod, the dependency graph generator 252 asynchronously updates the dependency graph to reflect the changes.

In some embodiments, the dependency graph generator 252 is operable to determine inter-resource dependencies by analyzing references within the IaC file associated with the application. For example, the dependency graph generator 252 can look for resource references in other resource definitions. For instance, if an EC2 instance resource references a security group resource, the dependency graph generator 252 identifies this dependency. In the pre-deployment mode, the dependency graph generator 252 receives parsed IaC data from the resource parser 242 and uses it to identify dependencies between resources. For example, a Terraform configuration defines an EC2 instance and a security group. The dependency graph generator 252 analyzes the configuration to determine that the EC2 instance depends on the security group for network access. In the post-deployment mode, as actual resources are allocated and configured, the dependency graph generator 252 updates the dependency graph with real-time data from the post-deployment updater 218.

For multi-stack deployments, the dependency graph generator 252 can correlate resources across different IaC files or modules to build a comprehensive dependency map. For example, if a deployment involves multiple Terraform stacks or CloudFormation stacks, the dependency graph generator 252 correlates resources across these stacks to map their interdependencies. In the pre-deployment mode, the dependency graph generator 252 analyzes different IaC files or modules to identify dependencies across stacks. For example, one Terraform stack defines an RDS instance, and another stack defines an application server that connects to the RDS instance. The dependency graph generator 252 identifies and maps this cross-stack dependency. In the post-deployment mode, as resources are allocated and configured, the dependency graph generator 252 updates the graph with real-time data from the post-deployment updater 218 to reflect the cross-stack dependencies. For example, the actual RDS instance ID and application server connection string are updated in the dependency graph to reflect the real-time inter-stack dependencies.

The graph storage 254 is a centralized database operable to store the dependency graphs (e.g., initial dependency graph and updated dependency graph over time). In some embodiments, each dependency graph is timestamped and associated with a unique execution ID or other identification information. In some embodiments, the graph storage 254 is integrated to database 106.

The post-deployment updater 218 within the automated dependency management system 154 is operable in conjunction with the dependency graph generator 252 and the change detection module 208 to timely update the current state of resources after the application is deployed. In some embodiments, the post-deployment updater 218 can analyze events from the deployment process of the application to identify created/allocated and modified resources associated with the application. For example, when a new EC2 instance is created/allocated to the application, the post-deployment updater 218 analyzes the event to obtain details such as the instance ID, IP address, and other attributes related to the new instance. In some embodiments, the post-deployment updater 218 can operate in conjunction with the dependency graph generator 252 to timely update the dependency graph generated by the dependency graph generator 252. For example, upon detecting the creation of a new Kubernetes pod for the application, the post-deployment updater 218 triggers the dependency graph generator 252 to add this Kubernetes pod to the dependency graph and establish its relationships with other resources. The post-deployment updater 218 can replace pre-deployment placeholder values (such as IPs, resource IDs, or ARNs) associated with the application with actual values assigned during deployment of the application. For example, if a placeholder IP address was used for an EC2 instance in the pre-deployment dependency graph, the post-deployment updater 218 updates this with the actual IP address assigned during deployment. The post-deployment updater 218 is also operable to incorporate live state information received from the state inspector 214 via event listener 216 to reflect the current state of the resources associated with the application. The post-deployment updater 218 is also operable to identify failed or partially completed resource creations/allocation/updates, initiate rollback procedures for failed deployments as required, and generate notifications containing detailed reports for various stakeholders. For example, if the deployment of a new microservice fails, the post-deployment updater 218 detects the failure, rolls back the changes, and notifies the development and operations teams with a detailed report containing all impacted components and relationships of the issue.

The event listener 216 within the automated dependency management system 154 is operable to capture and propagate real-time events from various sources, such as cloud providers, resource providers, CI/CD pipelines, among others. For example, when a new EC2 instance is launched on AWS for deployment of an application, the event listener 216 captures the event detailing the instance creation. The event listener 216 can filter and categorize incoming events based on their types, determine a relevance level, and identify the events that meet a predetermined threshold of the relevance level. For example, the event listener 216 can filter out events related to routine log entries and identify significant events such as resource creation/allocation, modification, or deletion. The event listener 216 can propagate captured events to other components (i.e., consumers) within the automated dependency management system 154 such as the post-deployment updater 218 and change detection module 208, based on predefined rules and event types. The event listener 216 can also maintain a predefined set of event types and their corresponding consumers, as well as a list of filters for events to be ignored. For example, the event listener can maintain a registry of event types like “Instance Launch,” “Kubernetes Pod Creation,” and “Database Modification,” and map them to consumers such as the post-deployment updater 218 and change detection module 208.

The visualization engine 224 within the automated dependency management system 154 is operable to transform infrastructure data into interactive visual representations. For example, the visualization engine 224 can generate dynamic graph visualizations that show resource relationships and dependencies over time and highlight how a change in one component affects others in the dependency graph. The visualization engine 224 can generate impact analysis maps that use color-coding to indicate the severity and scope of changes. The visualization engine 224 can support various visualization types, such as network diagrams, treemaps, and sunburst charts, and provide drill-down capabilities for detailed resource inspection. For example, the visualization engine 224 allows the administrator to click on a microservice in a dependency graph to view its detailed configuration, dependencies, and current status. The visualization engine 224 can provide customizable dashboards tailored to different users, for example, an operations dashboard configured to show real-time status and alerts for infrastructure components, and a developer dashboard configured to highlight code deployment statuses and service dependencies. The visualization engine 224 can generate visual diff reports for change analysis data and compare current and previous states upon request.

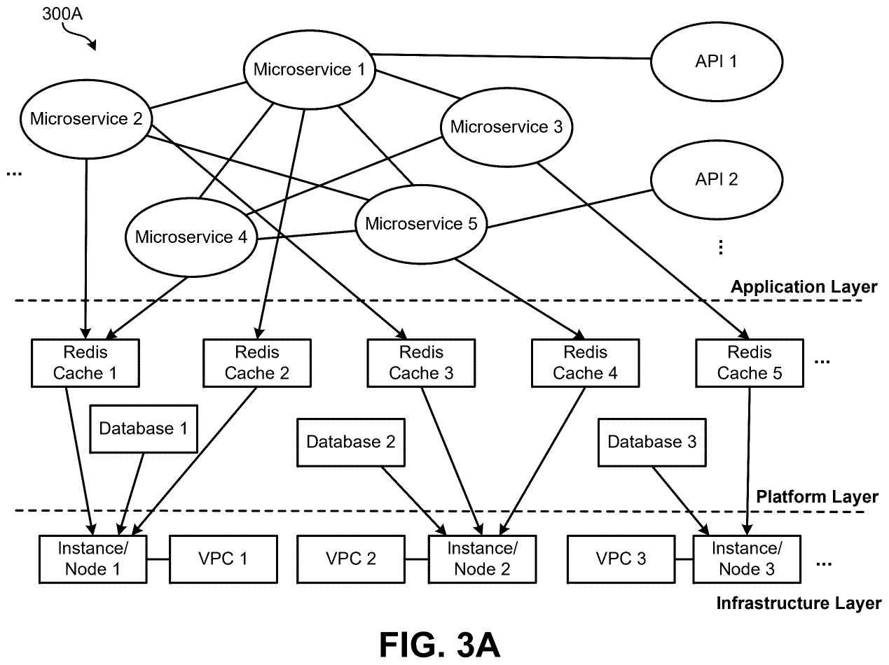

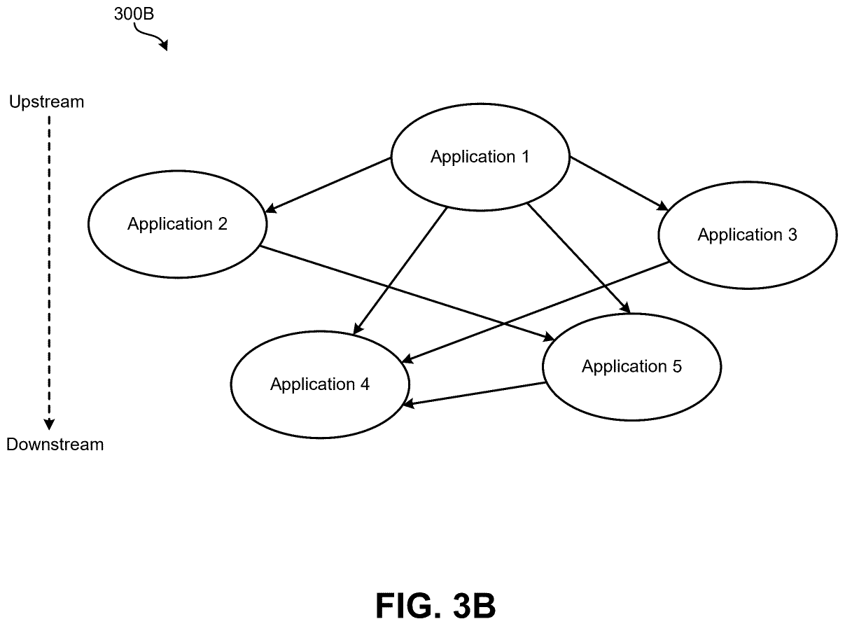

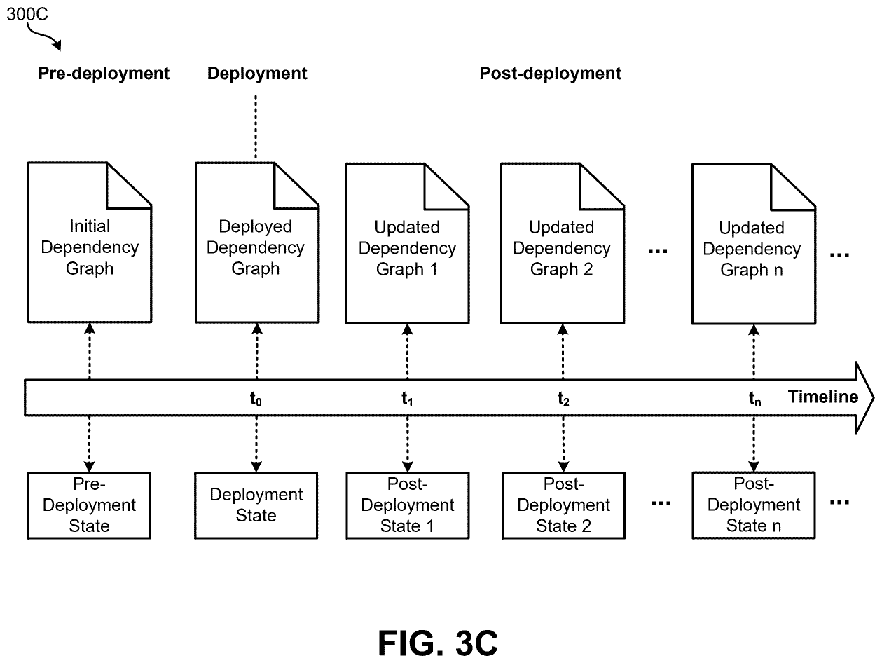

FIG. 3A is a schematic diagram illustrating an example of dependency graph 300A. The dependency graph 300A is associated with an application deployed in a target environment. In dependency graph 300A, the application may be an e-commerce service that includes multiple microservices 1-5 in the application layer. For example, microservice 1 is a user service operable to manage user profiles, authentication, and authorization. Microservice 2 is a product service operable to manage product catalog, product details, and inventory. Microservice 3 is an order service operable to manage order processing, order history, and order tracking. Microservice 4 is a payment service operable to manage payment processing and integrate with payment gateways. Microservice 5 is a notification service operable to send notifications (e.g., emails, SMS notifications) to users. API 1 is an internal communication API that includes a set of RESTful endpoints that allow the user service to communicate with the product service and order service to fetch user-specific product recommendations and order history. API 2 is an external communication API that includes a set of endpoints exposed via an API gateway that external clients (e.g., mobile apps, web apps) use to interact with the product service or order service.

Multiple Redis caches and databases are classified as platform resources. Redis caches are operable to cache frequently accessed data. For example, Redis cache 1 is used by user service for caching user session data. Redis cache 2 is used by product service for caching product data. Redis cache 3 is used by order service for caching order data. Redis cache 4 is used by payment service for caching payment transaction data. Redis cache 5 is used by notification service for caching notification data. The databases store persistent data. For example, Database 1 is a user database that stores user profiles, authentication details, and authorization information. Database 2 is a product database that stores product details, inventory information, and product metadata. Database 3 is an order database that stores order history, order details, and tracking information. Database 4 is a payment database that stores payment transactions, payment history, and related financial data.

Multiple instances/nodes and virtual private clouds (VPCs) are classified as infrastructure resources. Instances/nodes provide the compute resources needed to host the microservices and other infrastructure components. VPCs segment the infrastructure for security and manageability. Each instance/node can host a corresponding microservice or a group of microservices. Each VPC can host selected APIs and/or selected platform resources.

For example, the user service depends on the authentication service for user authentication and authorization, the user database for storing user profiles, Redis cache 1 for caching user session data, and API 1 for internal communication with other microservices, such as the product service and order service. The product service relies on the product database for product details, Redis cache 2 for caching product data, product database for storing product images, and API 1 for interacting with the user service and order service. The order service depends on the order database for order history, Redis cache 3 for caching order data, and other platform resources such as message queue for asynchronous order processing, using API 1 to communicate with the product service and payment service. The payment service requires the payment database for storing payment transactions, the message queue for processing payment requests, payment database for storing transaction logs, and API 1 for interactions with the order service. The notification service depends on the message queue for receiving notification requests, email service and SMS Service for sending notifications, notification database for storing notification logs, and API 1 for fetching notification content from other microservices.

FIG. 3B is a schematic diagram illustrating another example of dependency graph 300B. In the illustrated example, the dependency graph 300B schematically illustrates the dependency relationships among multiple applications (e.g., Application 1, Application 2, Application 3, Application 4, and Application 5) deployed in the same environment. For example, Application 1 may be an upstream application related to Application 2, Application 3, Application 4, and Application 5. Application 2 is a downstream application of Application 1 and an upstream application of Application 5. The dependency graph 300B may further indicate the dependency relationship among the components, data elements, and resources associated with one application and the components, data elements, and resources associated with another application.

FIG. 3C is a schematic diagram illustrating a process 300C of generating and updating dependency graphs for deployment of an application into a target environment. In the illustrated example, the dependency graph generator 252 operates in a pre-deployment mode and generates an initial dependency graph before deployment (i.e., before to). The initial dependency graph reflects/indicates a pre-deployment state, which may be a desired/expected state determined based on the IaC file associated with the application. At to, the application is deployed into a target environment. The state inspector 214 continuously monitors the resources associated with the application (e.g., the resources created for and allocated to the application) and identifies an initial deployment state (or deployment state) at to. The change detection module 208 identifies presence or absence of a change in the resources associated with the application by comparing the pre-deployment state and the initial deployment state. For example, the change detection module 208 may generate resource change data, output the changes and comparison results, and notify the CI/CD pipeline administrator of the output and changes. Once the changes are approved by the administrator, the dependency graph generator 252 generates a deployed dependency graph indicating the initial deployment state of the resources, based on the initial dependency graph and the detected changes by the change detection module 208.

Once the application is deployed (i.e., after to), the dependency graph generator 252 operates in the post-deployment mode and generates a series of updated dependency graphs respectively corresponding to various post-deployment states. For example, the post-deployment updater 218 operates to detect and identify events related to the resource and dependency changes associated with the application at a post-deployment time (e.g., t₁, t₂, . . . , tₙ), analyze the events to identify created, allocated, and modified resources associated with the application, and notify the state inspector 214 with the detected events. The state inspector 214 may determine a post-deployment state of the resources associated with the application at the specific time and update the dependency graph generator 252. The dependency graph generator 252 may generate an updated dependency graph for the specific time based on the data provided by the post-deployment updater 218 and the state inspector 214. The change detection module 208 may compare the updated dependency graph with the initial dependency graph, deployed dependency graph, or a previous updated dependency graph to identify and classify the change in resources and/or dependency relationships of the resources.

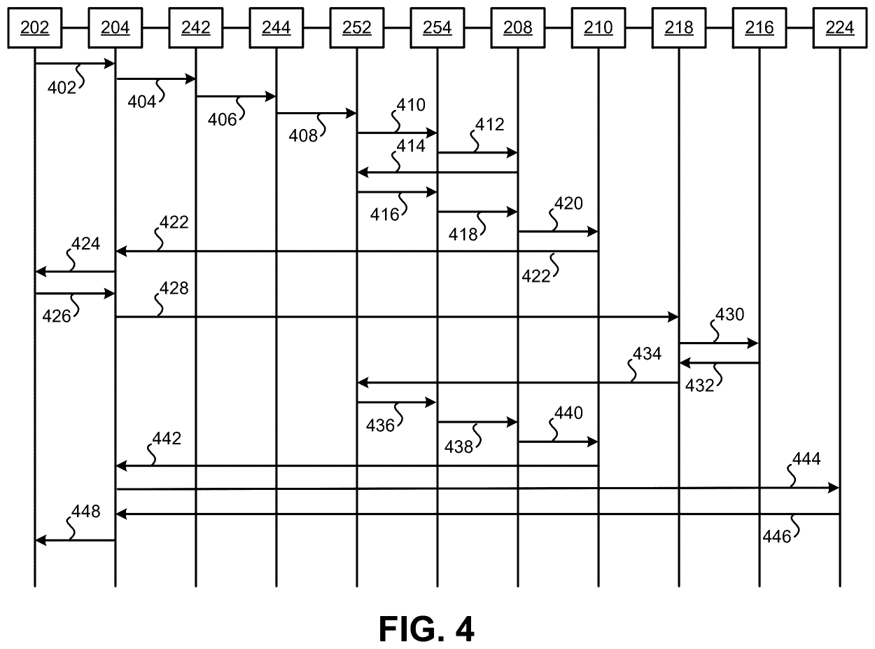

FIG. 4 is an example of a flow diagram illustrating data flow and interaction among components of the automated dependency management system 154. At 402, the CI/CD pipeline integration module 202 initiates deployment of an application or a change/update of an existing application in a target environment. The application may be deployed into a testing or production environment. At 404, the API 204 operates to trigger dependency checks or updates during the deployment process. For example, the API 204 provides access to an IaC file associated with the application and triggers the resource parser 242 to analyze the IaC file. The IaC file may be a YAML-based configuration file such as a Kubernetes manifest, an Ansible playbook, an AWS CloudFormation template, or a JSON-based configuration file such as an AWS CloudFormation template, a Terraform template, or other tool-specific formats.

The resource parser 242 operates in a pre-deployment mode to parse the IaC file, identify resources created for or allocated to the application, classify the resources, determine dependencies for the resources, and generate parsed IaC data (e.g., resource and dependency data). In some embodiments, the resources are classified as infrastructure layer resources, platform layer resources, and applicant layer resources. At 406, the resource parser 242 operates to provide the parsed IaC data to the label extractor 244. At 406, the label extractor 244 operates to perform layer classification of the resources based on the parsed IaC data and various pre-defined attributes of the resources, assign labels to the resources to indicate the class to which the resources belong, and generate labeled IaC data (e.g., labeled resource data).

At 408, the label extractor 244 provides access to the labeled IaC data to the dependency graph generator 252. The dependency graph generator 252 generates an initial dependency graph of the application. The initial dependency graph may represent a desired/expected state of the resources associated with the application and desired/expected dependency relationships of the resources (e.g., microservices, instances, nodes and edges, in-memory caches, databases, VPCs, etc.) associated with the application before deployment. At 410, the dependency graph generator 252 provides the graph storage 254 with the initial dependency graph. The graph storage 254 stores the initial dependency graph associated with the application.

At 412, the graph storage 254 operates to provide access to the initial dependency graph to the change detection module 208. The change detection module 208 operates in conjunction with the state inspector 214 to determine an initial deployment state of the resources associated with the application, compare the initial deployment state and the pre-deployment state, and detect/identify presence or absence of a change in the resources. At 414, the change detection module 208 operates to trigger the dependency graph generator 252 to generate post-deployment dependency graphs. At 416, the dependency graph generator 252 operates to generate a deployed dependency graph representing the initial deployment state of the resources associated with the application and stores the deployed dependency graph in the graph storage 254. At 418, the graph storage 254 provides access to the deployed dependency graph to the change detection module 208. The change detection module 208 may operate to compare the initial dependency graph and the deployed dependency graph, identify a change in resource and/or dependency relationship, heuristically assess the graph edit distance, identify a blast radius of the change, receive chaos testing results as input and consume the chaos testing results, classify the changes, calculate a risk score, and determine if the risk score exceeds a predetermined threshold. If the risk score is determined to exceed a predetermined threshold, the change detection module may operate to notify the administrator of the change via the API 204 and CI/CD pipeline integration module 202.

At 420, the change detection module 208 triggers the change impact analysis module 210 to perform change impact analysis to determine whether a change impact of a change between the initial deployment state and the pre-deployment state (e.g., a desired/expected/reference state) is acceptable. The change impact analysis module 210 can perform at least one of change cost estimation (e.g., whether a cost change against a predetermined reference exceeds a predetermined threshold), change blast radius evaluation (e.g., whether a blast radius change against a predetermined reference exceeds a predetermined threshold), and change performance cost evaluation (e.g., whether a performance cost change against a predetermined reference exceeds a predetermined threshold), generate an output of the change impact analysis, and provide the CI/CD pipeline administrator with the change impact output. At 422, the change impact analysis module 210 provides access to the change impact output to the API 204. At 424, the API 204 provides access to the change impact output to the CI/CD pipeline integration module 202 and sends a request to the administrator for review and approval of the change based on the change impact output. At 426, the CI/CD pipeline integration module 202 operates to approve the change.

At 428, upon receiving approval of the change, the API 204 operates to trigger the post-deployment update 218 to collect and update the resource data. At 430, the post-deployment update 218 operates to trigger the event listener 216. At 432, the event listener 216 operates to capture events associated with the application, identify relevant events (e.g., events related to the resource creation, allocation, and modification), generate deployment event data, and provide access to the deployment event data to the post-deployment update 218. At 434, the post-deployment update 218 operates to continuously monitor the events, analyze the deployment event data, and generate updated resource data. For example, the post-deployment update 218 operates to generate resource data such as the resource ID, IP address, and other attributes related to a new resource created for or allocated to the application, replace pre-deployment placeholder values (such as IPs, resource IDs, or ARNs) associated with the application with actual values assigned during deployment of the application in a relevant event, and provides the dependency graph generator 252 with the updated resource data.

At 436, the dependency graph generator 252 operates to update the dependency graph based on the updated resource data, generate updated dependency graphs reflecting the post-deployment state of the resources associated with the application, and store the updated dependency graphs in the graph storage 254. At 438, the graph storage 254 operates to provide access to the updated dependency graphs to the change detection module 208. The change detection module 208 may operate to compare the updated dependency graph and the initial and deployed dependency graphs, identify a change in the resources and/or dependency relationship, heuristically assess the graph edit distance, identify/determine a blast radius of the change, consume the chaos testing results on the changes, classify the changes, calculate a risk score for the change, and determine if the risk score exceeds a predetermined threshold. If the risk score is determined to exceed a predetermined threshold, the change detection module may operate to notify the administrator of the change via the API 204 and CI/CD pipeline integration module 202.

At 440, the change detection module 208 triggers the change impact analysis module 210 to perform change impact analysis to determine a change impact of a change between a post-deployment state and the pre-deployment state (e.g., a desired/expected/reference state) is acceptable. The change impact analysis module 210 can perform at least one of change cost estimation, change blast radius evaluation, and change performance cost evaluation, generate an output of the change impact analysis, and provide the CI/CD pipeline administrator with the change impact output. At 442, the change impact analysis module 210 provides access to the change impact output to the API 204. At 444, the API 204 triggers the visualization engine 224 to visualize the dependency graphs associated with the application. At 446, the visualization engine 224 provides access to the visualization results to the API 204. The API 204 provides access to the visualized dependency graphs to the CI/CD pipeline administrator via CI/CD pipeline integration module 202.

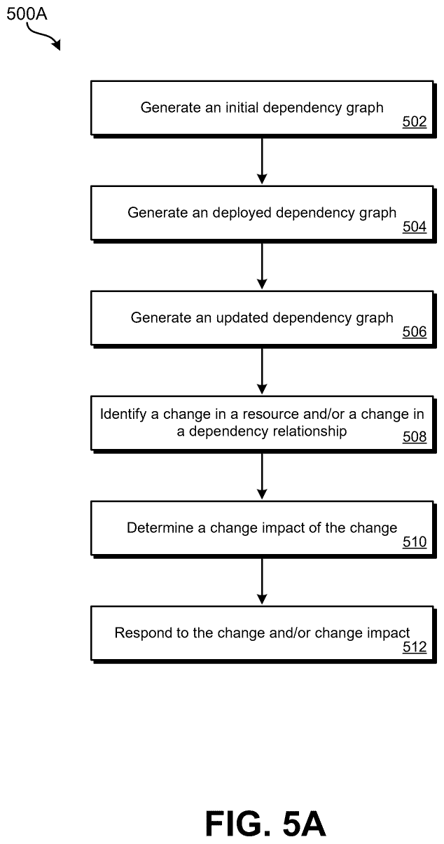

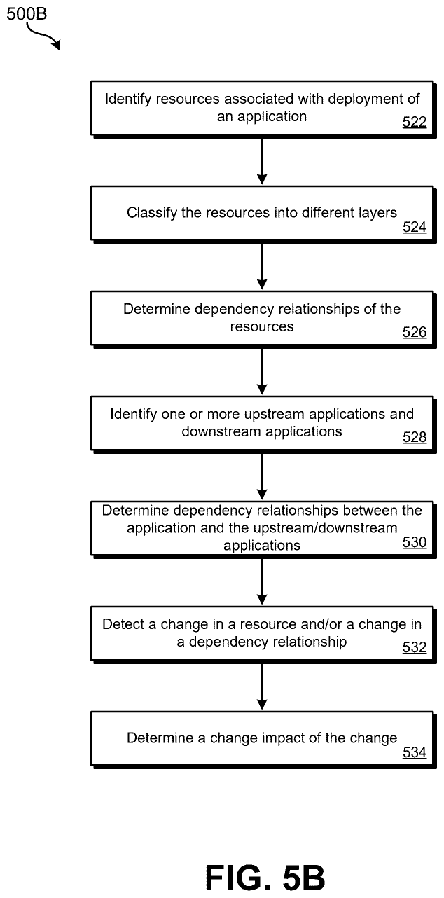

FIG. 5A is a block diagram illustrating an example method 500A of automated dependency management for deployment of an application. Method 500A may be performed by a computer system such as the automated dependency management system 154 alone or in conjunction with other components of the deployment management system 104 shown in FIG. 1. Method 500A includes process blocks 502-512. Fewer or additional process blocks may be included, and process blocks of method 500A may be combined with process blocks of other methods or processes provided in the present application in a suitable manner.

At block 502, an initial dependency graph of an application is generated by the automated dependency management system 154. The application is to be deployed in a target environment such as a pre-production testing environment (e.g., a lower environment) or a production environment. The initial dependency graph corresponds to a pre-deployment state of resources associated with the application before it is deployed. The pre-deployment state may be a desired/expected state or a reference state determined by the automated dependency management system 154 based at least in part on a predetermined configuration file such as an IaC file associated with the application. In some embodiments, the IaC file associated with the application is accessed by the automated dependency management system 154, and parsed by the automated dependency management system 154 to identify the resources associated with the application. Each resource is labeled and assigned by the automated dependency management system 154 an identifier.

In some embodiments, the resources are classified by the automated dependency management system 154 into multiple layers and labeled, and the dependency relationships are determined by the automated dependency management system 154. The dependency relationships include relationships of the resources within the same layer and relationships of the resources in different layers. In some embodiments, the plurality of layers includes an application layer having microservices, web applications, mobile applications, etc., associated with the application, a platform layer comprising in-memory caches relational databases, message queues, discovery services, etc., associated with the application, and an infrastructure layer comprising one or more computing instances (e.g., instances, servers, nodes, edges, etc.), one or more databases and data storages, and one or more networking components (e.g., load balancers, firewalls, etc.), associated with the application.

At 504, a deployed dependency graph is generated by the automated dependency management system 154. The deployed dependency graph corresponds to an initial deployment state at the time when the application is deployed in the target environment. The deployed dependency graph indicates the resources associated with the application and the dependency relationships of the resources at the time when the application is deployed in the target environment.

At 506, one or more updated dependency graphs are periodically generated by the automated dependency management system 154 after the application is deployed in the target environment. Each updated dependency graph corresponds to a post-deployment state at a specific time and indicates the resources associated with the application and the dependency relationships of the resources at the specific time. The initial dependency graph, deployed dependency graph, and updated dependency graphs can be visualized by the automated dependency management system 154.

At 508, a change in a resource or a dependency relationship associated with the application is detected and identified, by the automated dependency management system 154. In some embodiments, the initial dependency graph and the deployed dependency graph are compared to determine whether they are isomorphic. A change is detected if the initial dependency graph and the deployed dependency graph are not isomorphic. If the initial dependency graph and the deployed dependency graph are isomorphic, one or more subgraphs of the initial dependency graph and the deployed dependency graph are compared. A change is detected if the one or more subgraphs of the initial dependency graph and the deployed dependency graph are not isomorphic. The change in the resources and/or the dependency relationship is identified by heuristically assessing the graph edit distance. The change in the resources is further classified. For example, a change in resources can be classified into a relational/behavioral change (e.g., a change in an edge of the infrastructure resources) or an additive/destructive change (e.g., a change in a node of the infrastructure resources) or an updating change (e.g., a property change).

At 510, a change impact of the change is determined by the automated dependency management system 154. The change impact can be based on at least one of change cost determination, change blast radius determination, and change performance cost determination.

At 512, a response to the change and the change impact is made by the automated dependency management system 154. In some embodiments, if a change in resources or a change in dependency relationships associated with the application between the initial dependency graph and the deployed dependency graph, an alert can be generated, and the CI/CD pipeline administrator or relevant stakeholder is notified of the change. The deployment of the application can be caused to cease, if the change type is not acceptable and/or the change impact exceeds a predetermined threshold.

FIG. 5B is a block diagram illustrating an example method 500B of automated dependency management for deployment of an application. Method 500B may be performed by a computer system such as the automated dependency management system 154 alone or in conjunction with other components of the deployment management system 104 shown in FIG. 1. Method 500B includes process blocks 522-534. Fewer or additional process blocks may be included, and process blocks of method 500B may be combined with process blocks of other methods or processes provided in the present application in a suitable manner.

At 522, resources associated with an application to-be-deployed in a target environment are identified by the automated dependency management system 154. The resources can be identified by analyzing a predetermined configuration file such as an IaC file associated with the application. A dependency graph of the application can be generated.

At 524, the resources are classified into different types based on the attributes of the resources. In some embodiments, the resources are classified into an infrastructure layer, a platform layer, and an application layer.

At 526, the dependency relationships of the resources are determined from the dependency graph. The dependency relationships include relationships of the resources within the same layer and relationships of the resources in different layers.

At 528, one or more upstream applications and one or more downstream applications related to the application are identified. In some embodiments, the upstream applications and downstream applications can be identified from the IaC file associated with the application, data flow diagrams, sequence diagrams, API calls, service interactions, real-time network traffic data, etc. The dependency graph of the application includes the upstream applications and downstream applications.

At 530, dependency relationships between the application and the upstream/downstream applications are determined. In some embodiments, the dependency relationships between a component (e.g., microservice, node, database, etc.) of the application and a component (e.g., microservice, node, database, etc.) of the upstream/downstream applications are determined. The dependency graph of the application includes the dependency relationships between the application and the upstream/downstream applications.

At 532, a change in a resource and/or a change in a dependency relationship of the resources associated with the application between a first state of the resources and a second state of the resources is determined by the automated dependency management system 154. The first state may be a pre-deployment state before the application is deployed, which can be a desired/expected state or a predetermined reference state. The second state may be an initial deployment state at the time when the application is deployed, or a post-deployment state at a time after the application is deployed. The change may be detected and identified by comparing the dependency graphs respectively corresponding to the first state and the second state.

At 534, a change impact of the change is determined by the automated dependency management system 154. The change impact can be based on at least one of change cost determination, change blast radius determination, and change performance cost determination.

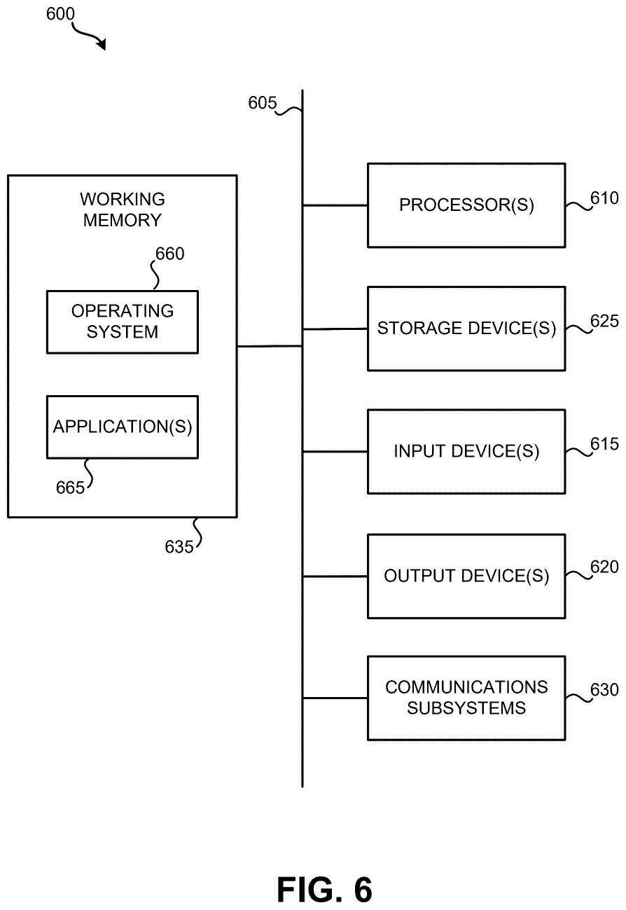

The system 100 and any components thereof, such as the automated dependency management system 154 and various components thereof, etc., as described above may be implemented on a computer system that further includes computer hardware and software that form special-purpose network circuitry to implement various embodiments such as communication, accessing data, calculation, identification, detection, determination, and other operations or steps of the methods or processes described herein. FIG. 6 is a schematic diagram illustrating an example of computer system 600. The computer system 600 is a simplified computer system that can be used to implement various embodiments described and illustrated herein. FIG. 6 provides a schematic illustration of one embodiment of a computer system 600 that can perform some or all of the steps of the methods and workflows provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown including hardware elements that can be electrically coupled via a bus 605, or may otherwise be in communication, as appropriate. The hardware elements may include one or more processors 610, including without limitation one or more general-purpose processors and/or one or more special-purpose processors such as digital signal processing chips, graphics acceleration processors, and/or the like; one or more input devices 615, which can include without limitation a mouse, a keyboard, a camera, and/or the like; and one or more output devices 620, which can include without limitation a display device, a printer, and/or the like.

The computer system 600 may further include and/or be in communication with one or more non-transitory storage devices 625, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 630. In other embodiments, a portable electronic device, e.g., the first electronic device, may be incorporated into the computer system 600, e.g., an electronic device as an input device 615. In some embodiments, the computer system 600 will further include a working memory 635, which can include a RAM or ROM device, as described above.

The computer system 600 also can include software elements, shown as being currently located within the working memory 635, including an operating system 660, device drivers, executable libraries, and/or other code, such as one or more application programs 665, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 6, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 625 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the operations of such methods are performed by the computer system 600 in response to processor 610 executing one or more sequences of one or more instructions, which might be incorporated into the operating system 660 and/or other code, such as an application program 665, contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 and/or components thereof generally will receive signals, and the bus 605 then might carry the signals and/or the data, instructions, etc. carried by the signals to the working memory 635, from which the processor(s) 610 retrieves and executes the instructions. The instructions received by the working memory 635 may optionally be stored on a non-transitory storage device 625 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a test case” includes a plurality of such test cases, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered.

What is claimed is:

1. A computer system comprising:
one or more processors; and
a computer-readable storage media storing computer-executable instructions, wherein, the instructions when executed by the one or more processors, cause the computer system to:
generate an initial dependency graph for an application to be deployed in a target environment, the initial dependency graph indicating a predetermined reference state of resources associated with the application and dependency relationships of the resources;
track, continuously, the resources associated with the application once the application is deployed in the target environment;
generate an updated dependency graph for the application after the application is deployed, the updated dependency graph corresponding to an updated state of the resources associated with the application and the dependency relationships of the resources; and
detect a change in at least one of the resources and/or a change in at least one of the dependency relationships of the resources between the updated state and the reference state.

2. The computer system of claim 1, wherein the instructions when executed by the one or more processors further cause the computer system to:
classify the resources into a plurality of layers and label each layer; and
determine the dependency relationships of the resources,
wherein the dependency relationships comprise relationships of the resources within the same layer and relationships of the resources across different layers.

3. The computer system of claim 2, wherein the plurality of layers comprises:
an application layer comprising one or more microservices associated with the application;
a platform layer comprising one or more in-memory caches associated with the application; and
an infrastructure layer comprising one or more computing instances, one or more databases, and one or more networking components, associated with the application.

4. The computer system of claim 2, wherein the instructions when executed by the one or more processors further cause the computer system to:
classify the change in the resource based on the layer of the resource.

5. The computer system of claim 1, wherein the instructions when executed by the one or more processors further cause the computer system to:
determine whether the updated dependency graph and the initial dependency graph are isomorphic,
wherein the change is detected when the updated dependency graph and the initial dependency graph are not isomorphic.

6. The computer system of claim 1, wherein the instructions when executed by the one or more processors further cause the computer system to:
determine a change impact of the change between the updated state and the reference state; and
generate an alert when the change impact exceeds a predetermined threshold.

7. The computer system of claim 1, wherein the instructions when executed by the one or more processors further cause the computer system to:
access an infrastructure as code (IaC) file associated with the application;
parse the IaC file to identify the resources associated with the application;
assign an identifier to each one of the identified resources; and
determine the reference state of the resources associated with the application and dependency relationships of the resources.

8. The computer system of claim 7, wherein the instructions when executed by the one or more processors further cause the computer system to:
assign a placeholder value to the identifier before the application is deployed;
obtain an actual value to the identifier after the application is deployed; and
replace the placeholder value with the actual value.

9. The computer system of claim 1, wherein the instructions when executed by the one or more processors further cause the computer system to:
generate a deployed dependency graph corresponding to an initial deployment state of the resources at a time when the application is deployed;
determine presence or absence of a change in at least one of the resources and/or at least one of the dependency relationships between the initial deployment state and the reference state;
determine a change impact of the identified change between the initial deployment state and the reference state exceeds a predetermined threshold; and
cause the deployment of the application to cease, when the change impact exceeds a predetermined threshold.

10. The computer system of claim 1, wherein the instructions when executed by the one or more processors further cause the computer system to:
track, continuously, deployment events associated with the application once the application is deployed;
identify the deployment events relevant to the resources associated with the application,
wherein the change in the resources and the dependency relationships of the resources between the updated state and the reference state is identified based at least in part on the deployment events.

11. A method comprising:
generating an initial dependency graph for an application to be deployed in a target environment, the initial dependency graph indicating a predetermined reference state of resources associated with the application and dependency relationships of the resources;
tracking, continuously, the resources associated with the application after the application is deployed in the target environment;
generating an updated dependency graph for the application after the application is deployed, the updated dependency graph corresponding to an updated state of the resources associated with the application and the dependency relationships of the resources; and
detecting a change in at least one of the resources and/or a change in at least one of the dependency relationships of the resources between the updated state and the reference state.

12. The method of claim 11, further comprising:
classifying the resources into a plurality of layers and label each layer; and
determining the dependency relationships of the resources,
wherein the dependency relationships comprise relationships of the resources within the same layer and relationships of the resources across different layers.

13. The method of claim 12, wherein the plurality of layers comprises:
an application layer comprising one or more microservices associated with the application;
a platform layer comprising one or more in-memory caches associated with the application; and
an infrastructure layer comprising one or more computing instances, one or more databases, and one or more networking components, associated with the application.

14. The method of claim 12, further comprising:
classifying the change in the resource based on the layer of the resource.

15. The method of claim 11, further comprising:
determining whether the updated dependency graph and the initial dependency graph are isomorphic,
wherein the change is detected when the updated dependency graph and the initial dependency graph are not isomorphic.

16. The method of claim 11, further comprising:
determining a change impact of the change between the updated state and the reference state; and
generate an alert when the change impact exceeds a predetermined threshold.

17. The method of claim 11, further comprising:
accessing an infrastructure as code (IaC) file associated with the application;
parsing the IaC file to identify the resources associated with the application;
assigning an identifier to each one of the identified resources; and
determining the reference state of the resources associated with the application and dependency relationships of the resources.

18. The method of claim 17, further comprising:
assigning a placeholder value to the identifier before the application is deployed;
obtaining an actual value to the identifier after the application is deployed; and
replacing the placeholder value with the actual value.

19. The method of claim 11, further comprising:
generating a deployed dependency graph corresponding to an initial deployment state of the resources at a time when the application is deployed;
determining presence or absence of a change in at least one of the resources and/or at least one of the dependency relationships between the initial deployment state and the reference state;
determining a change impact of the identified change between the initial deployment state and the reference state exceeds a predetermined threshold; and
causing the deployment of the application to cease, when the change impact exceeds a predetermined threshold.

20. The method of claim 11, further comprising:
tracking, continuously, deployment events associated with the application once the application is deployed;
identifying the deployment events relevant to the resources associated with the application,
wherein the change in the resources and the dependency relationships of the resources between the updated state and the reference state is identified based at least in part on the deployment events.
